(19) United States
(12) Patent Application Publication
(10) Pub. No.: US 2010/0131845 A1
(43) Pub. Date: May 27, 2010

(54) HUMAN INTERFACE OF A MEDIA PLAYING DEVICE

(75) Inventor: Heather Marie Pann, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/324,022

(22) Filed: Nov. 26, 2008

(51) Int. Cl. G06F 3/048

(52) U.S. Cl. 715/716

(57) ABSTRACT

A method and device for selectively playing media files stored in a media playing device. The media playing device includes a first database for housing a plurality of media files, and a first and second menu. The first menu displays a plurality of media file identifiers, upon selection of one of the media file identifiers, the second menu is presented. The second menu contains a category list configured so as to present each category having a media file tagged with the selected media file identifier. The interface is operable to choose one of the categories from the category list and either play one media file, all the media files tagged with the media file identifier, or all the media files within the selected category.

### FIELD OF THE INVENTION

The present invention relates to a method and device for selectively playing media files. Specifically, the invention relates to a method and device for selectively playing an entire category of media files stored in the media playing device based upon the selection media file identifier.

### BACKGROUND OF THE INVENTION

Media playing devices are common and known and typically provide an interface for navigating a menu so as to selectively choose a media file. One function of such device is to facilitate playing media files. Currently such devices provide different ways in which media file arrangements may be played. For example, playing arrangements may be based upon the artist, or the album or may be in the form of a playlist which is manually constructed and individualized.

Media playing devices provide other methods of presenting music selection besides just perusing through the media file database in an alphabetical manner. For instance, U.S. Pat. No. 7,196,258 to Platt discloses a device or method that generates playlists for a library or collection of media items by selecting a plurality of seed items. Some of the seed items are identified as being desirable, thus indicative that a user prefers additional media items similar to the desirable seed items and others are identified as being undesirable and indicative that the user prefers additional media items dissimilar to the undesirable seed items. A comparison of the user selection is made by the device by looking at the seed items and determining which media items are to be added into the playlist by computation of similarity of metrics or values. Thus a playlist can be regenerated by adding desirable seed items to the playlist and removing media items from the playlist, for example undesirable seed items.

U.S. Pat. No. 6,721,489 to Benyamin et al. discloses a playlist manager that can be used to create and update playlists. The user will create a playlist and specify certain criteria for automatically adding tracks to the playlist. When a track is added to the environment, specifically the playlist, the device tests whether the track's properties satisfy the criteria for the playlist itself. If so, the new track is automatically added to the playlist so as to eliminate the need for the user to manage the playlist.

As is commonly known in the art, media playing devices such as the Ipod® and other similar MP3 playing devices have a menu for presenting a selection of media files. These media files are presented based upon a media file identifier such as the artist's name, genre and the like. The selection process is very linear and avails only files associated with the media file identifier for selection. For instance, upon selecting the artist the user is then presented with a complete selection of artists that are available within the player. With reference to FIG. 2, the user will then be presented with the different albums in which the artist appears in and the user can then select the album and either play the only songs of the album in which the artist appears, or an individual song of the selected artist. However, it is desirable to have a device and a method whereby a user is not limited to just the selection of the songs written by a particular artist within an album but rather the entire album in which the artist appears. It is also desirable to have a device and method whereby the user is able to selectively play an entire category of media files stored in the media playing device based upon the selection of one media file.

### SUMMARY OF THE INVENTION AND ADVANTAGES

A method and device for selectively playing media files. The method includes the steps of providing a media playing device having a first database populated with a plurality of predefined categories. Loading a plurality of media files into the first database. Tagging each of the media files with at least one media file identifier. Populating the predefined categories with media files such that the media file identifier is placed in a corresponding predefined category.

The method further includes the step of providing a search engine for locating each of the media files based upon the plurality of media file identifiers. A first menu, a second menu, and an interface operable to navigate the first and second menu is also provided. Preferably, the first menu presents an identifier list which includes each of the plurality of media file identifiers. The interface is operable to choose one of the media file identifiers. Upon selection of a media file identifier, the second menu is presented. The second menu presents a category list. The category list includes each category that is populated with media files tagged with the chosen media file identifier in the previous step. The interface is operable to select a category and then selectively play one media file, all the media files tagged with the selected media file identifier, or the entire selected category.

A media playing device is also provided. The media playing device selectively plays a predetermined arrangement of media files. The media playing device includes a housing for containing various electrical components (not shown) that provide computing operations for the media playing device, and a first database for storing a plurality of predefined categories. Each of the plurality of predefined categories contain media file(s), and each media file is tagged at least one media file identifier.

The device further includes a first menu and a second menu. The first menu has an identifier list which contains the media file identifiers. The second menu has a category list that is generated based upon the selection of the media file identifier so as to present all the categories having a media file tagged with the selected media file identifier. An interface operable to navigate the first and second menu is also provided. In operation, the device initially provides the first menu and the interface is operable to choose one of the media file identifiers presented in the identifier list. Upon choosing a media file identifier, the device presents the second menu. The second menu generates a category list so as to present each of the plurality of categories populated with media files tagged with the chosen media file identifier, and the interface is operable to choose one of the categories and either play an individual media file within the category, all the media files tagged with the selected media file identifier, or the entire category.

### BRIEF DESCRIPTION OF THE DRAWINGS

FIG. 1 is a diagram illustrating the steps in a method for selectively playing an entire category of media files stored in an media playing device based upon the selection of one media file;

FIG. 2 is a diagram illustrating the prior art method of selectively playing media files using a media playing device;

FIG. 3 is a flow diagram illustrating the operation of the method;

FIG. 4 is a perspective view of a media playing; and

FIGS. 5a-5d are a step by step illustration of the operation of the media playing device.

### DETAILED DESCRIPTION OF THE INVENTION

Referring to the Figures, wherein like numerals indicate corresponding parts throughout the several views, a method 10 for selectively playing media files 12 stored in a media playing device 14, and a media playing device 14 for selectively playing a predetermined arrangement of media files 12 are provided. As described above, there are various methods for selectively playing media files. However, such known methods require numerous steps in order to achieve a desired selection. The method 10 described herein reduces the number of steps currently required in the art so as to facilitate a greater selection of media file arrangements. Specifically, current media file playing devices require an end user to create a playlist in order to play a desired arrangement, or are not configured to allow an end user to play a media file 12 that is not based upon an initial search criterion. For instance, current devices, such as an Ipod®, allows end users to search the device for songs using a criteria such as an artist's name. When the end user selects a desired artist name, such as “Billy Joel,” the end user will be able to play different arrangements media files 12 tagged with “Billy Joel,” but will not allow an end user to play songs that are not tagged with “Billy Joel.” Thus, the end user is forced to take further steps such as creating a playlist of media files 12 having “Billy Joel” and any other desired artist. The method 10 disclosed herein provides a greater selection of media file 12 arrangements wherein at least one selection media file 12 arrangements has no direct association with the initial search criteria.

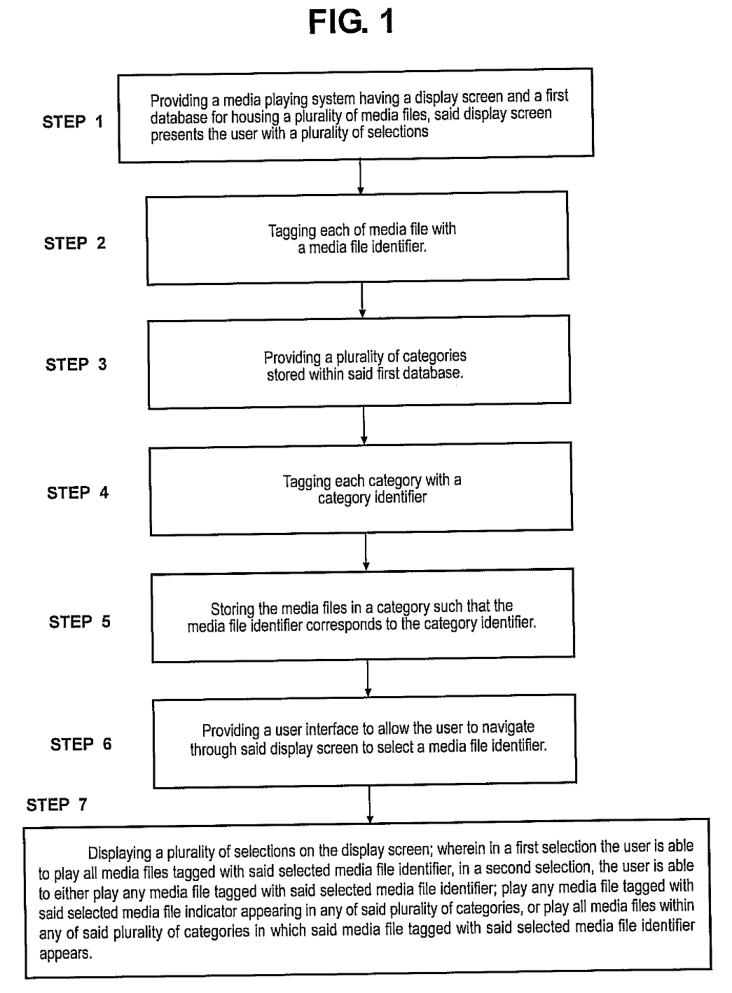

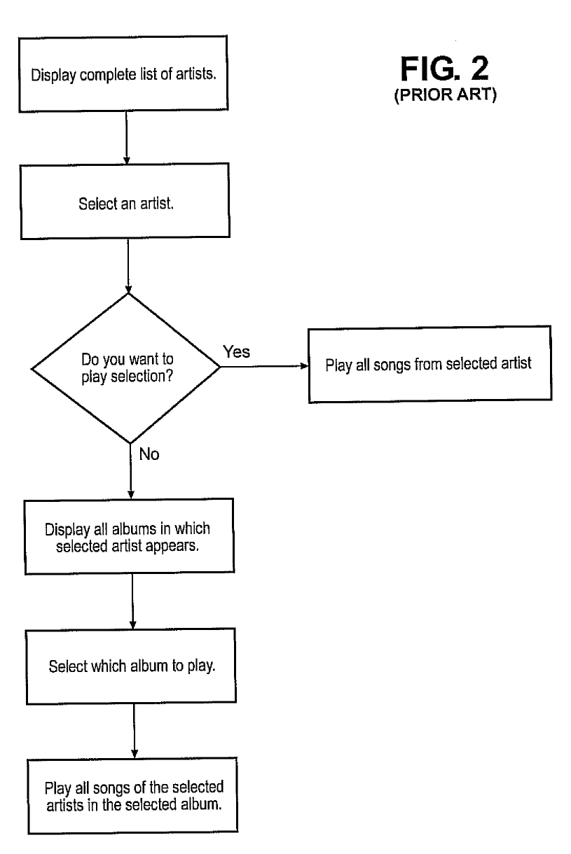

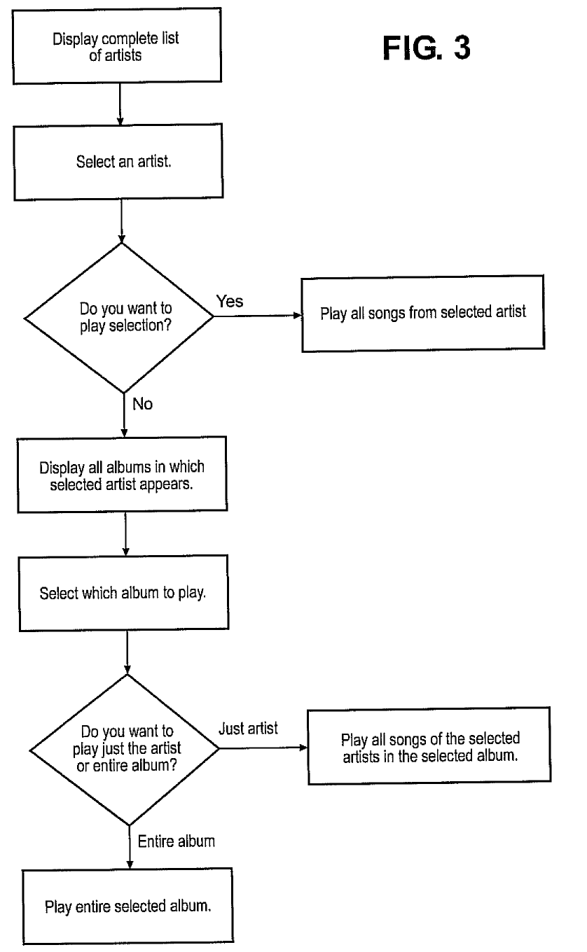

With reference now to FIG. 1, a method 10 for selectively playing media files 12 stored in a media playing device 14 includes the steps of providing a media playing device 14 having a first database 16 populated with a plurality of predefined categories 18. The predefined categories 18 may be defined by a group of the media files 12 according to the album title, artist name, year the media file 12 was authored, playlist, the location where the media file 12 was authored, or the like. A plurality of media files 12 are then loaded into the first database 16. Each of the media files 12 is tagged with at least one media file identifier 20 using metadata or the like. The media file identifier 20 may identify the media file 12 by an artist's name, the year the media file 12 was authored, and/or the location where the media file 12 was authored.

The predefined categories 18 are then populated with at least one media file 12 such that the media file identifier 20 is placed in a corresponding predefined category 18. For example a predefined category 18 labeled “Billy Joel” may have numerous media files 12 tagged with “Billy Joel,” or alternatively, a predefined category 18 labeled “1980s” may have media files 12 tagged with any year in the “1980s.” Thus it follows that a particular media file 12 may be housed in more than one predefined category 18.

The method 10 further includes the step of providing a search engine 22 for locating each of the media files 12 based upon the plurality of media file identifiers 20. The search engine 22 is known technology that uses terms to retrieve media file identifiers 20 such as metadata. Thus, an end user may be able to retrieve any media file 12 within the database associated with the term “Billy Joel” using a search term such as “Billy Joel.”

The method 10 further includes providing a first menu 24, a second menu 26, and an interface 28 operable to navigate the first and second menu 24, 26. Preferably, the first menu 24 presents an identifier list 30. The identifier list 30 includes each of the plurality of media file identifiers 20, and the interface 28 is operable to choose one of the media file identifiers 20. Thus, the identifier list 30 presents to the end user each artist by name, a list of years, a list of locations, genres or the like, by which the end user may select so as to form a search criteria for selecting media files 12. The method 10 then proceeds to choosing one of the plurality of media file identifiers 20 from the identifier list 30. Upon selection of a media file identifier 20, the second menu 26 is presented. The second menu 26 presents a category list 32. The category list 32 includes each category that is populated with media files 12 tagged with the chosen media file identifier 20 in the previous step. The interface 28 is operable to then choose any category from the category list 32.

The method 10 may further include the step of organizing the identifier list 30 into a plurality of media file groups 34 so as to provide a more organized presentation of selections for the end-user. Thus, the first menu 24 instead of just presenting a list of each media file identifier provides a list of media files groups 34. The media file groups 34 may group the media file identifiers 20 alphabetically, this allows the end user to quickly navigate through the first database 16. The media file groups 34 may be presented in a list, herein referred to as a media file group list 36. The media file group list 36 may be an alphabetical list, wherein upon selection of a particular letter, the media file identifiers 20 beginning with the selected letter are presented. For instance, the interface 28 is operable to selectively choose one of the media file groups 34 such as the letter “D” from the media file group list 36. Upon selection of the letter “D”, all of the media file identifiers 20 beginning with “D” such as “Dave Mathews Band,” “Danzig,” and “Def Leppard” are presented to the user for selection. Thus, the media file group 34 can facilitate a search of media files 12.

Alternatively, the media file group list 36 may organize the media file search by artist name, genre, or the like. Once the end user decides which media file group 34 he/she wants to view, all the media file identifiers 20 contained in the selected media file group 34 are presented. Thus, an end-user may want to browse the first data base 16 by the group labeled “genre,” and upon selection of the group “genre” all the media file identifiers 20 labeled by genre are presented to the end-user for further selection.

In a first preferred embodiment, the method 10 provides the end-user with the choice of playing either one or many media files 12. Specifically, the interface 28 is operable to selectively play from the category list 32 either, one media file 12 tagged with the chosen media file identifier 20 or all of the media files 12 tagged with the chosen media file identifier 20, or the entire contents of the selected category. Thus, when the end-user chooses a media file identifier 20 from which to browse the first database 16, the second menu 26 will present a category list 32 having all media files 12 tagged with the selected media file identifier 20. The end-user may then operate the interface 28 so as to either choose to play one of the media files 12 presented, or all of the media files 12 having the selected media file identifier 20, or the entire contents of the selected category. Thus when the category is an album containing a compilation of various artists, the method 10 allows for the selection of media files 12 not just based upon a prior selection of a particular media file identifier 20. For example, a movie soundtrack may have songs from artists such as “Led Zeppelin,” “Rush,” and “The Who.” If the user selects “Led Zeppelin” as a media file identifier 20, the second menu 26 will present various predefined categories 18 containing media files 12 having “Led Zeppelin” as a media file identifier 20, such as a soundtrack, a playlist, or other albums tagged with “Led Zeppelin.” The second menu 26 presents the user with the choice of any of these categories 18, 38, and upon selection allows the user to play one media file 12 from the chosen category, all media files 12 from the chosen category having “Led Zeppelin” as a media file identifier 20, or all the media files 12 in the category. Thus unlike the prior art, the method 10 is not linear especially when the category is a compilation that contains various other artists because the user is presented with song selections that were not the basis of the initial search criterion.

In certain cases, the end-user may want to create a playlist. The method 10 includes the step of incorporating the created playlist into a selection available in the second menu 26. Thus, the interface 28 is operable to create a plurality of playlists, also referred to herein as customizable categories 38, and each of the customizable category 38 is stored in the first database 16. The category list 32 further includes each of the plurality of customizable categories 38, and the interface 28 is operable to selectively play any of the items within the category list 32, namely the customizable categories 38 and predefined categories 18. It is understood, that the category list 32 is generated based upon the media file 12 indicator selected in the first menu 24.

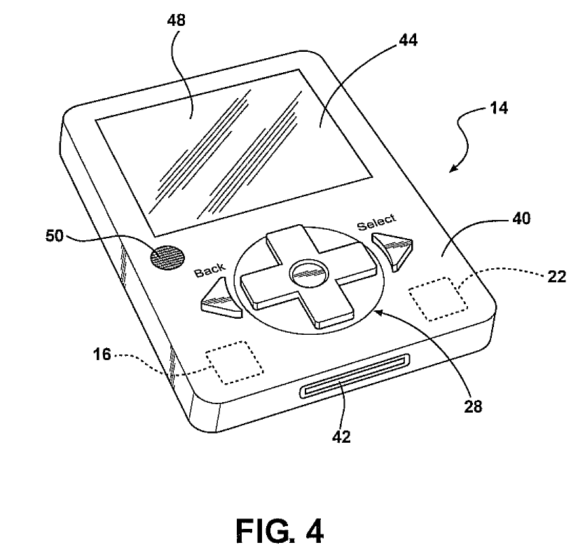

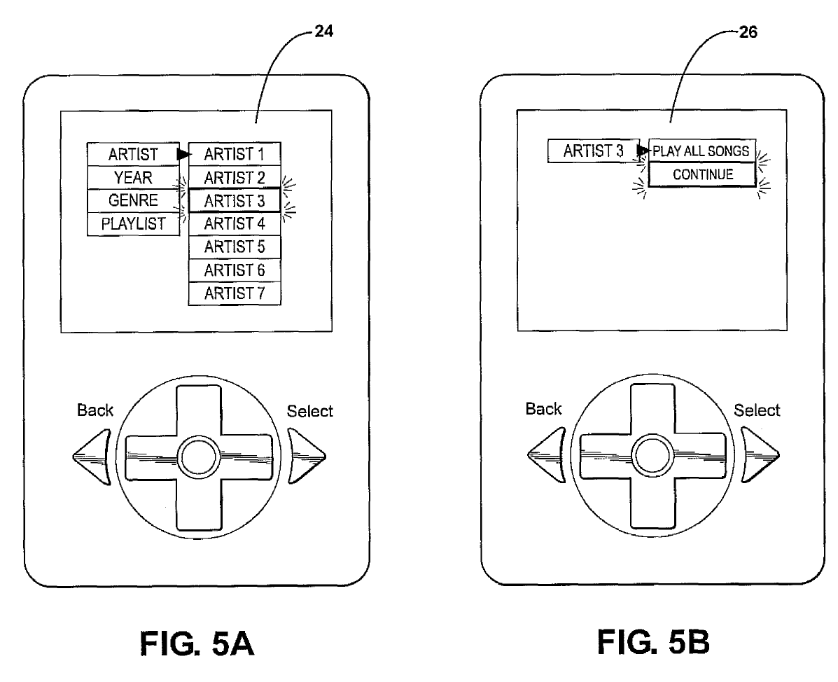

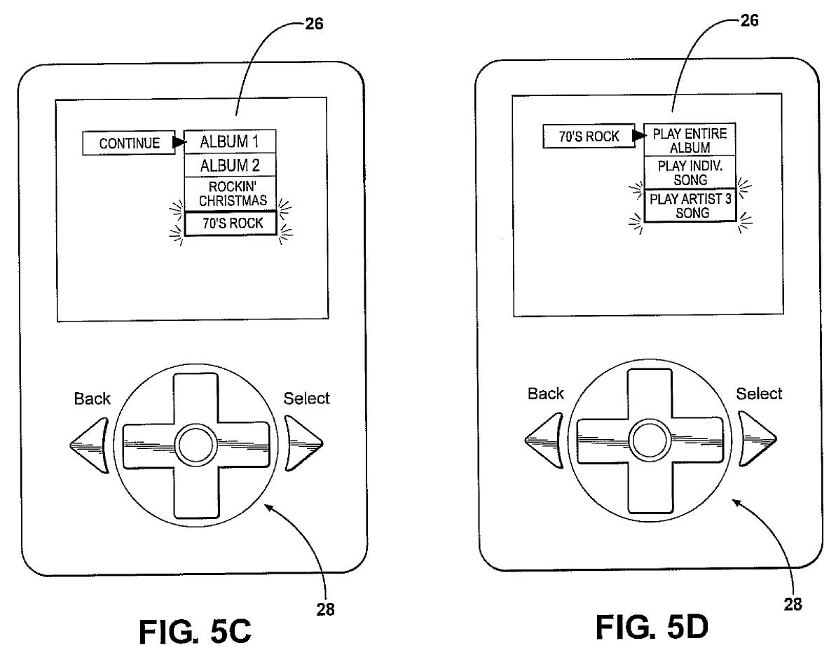

With reference now to FIGS. 4 and 5a-5d, a media playing device 14 for selectively playing a predetermined arrangement of media files 12 is illustrated. The media playing device 14 includes a housing 40 for containing various electrical components (not shown) that provide computing operations for the media playing device 14, and a first database 16 (not shown) for storing a plurality of predefined categories 18. The predefined categories 18 include but are not limited to the album title, artist name, year the media file 12 was authored, customizable playlist, and the location where the media file 12 was authored. Each of the plurality of predefined categories 18 contain media file(s) 12, and each media file 12 is tagged at least one media file identifier 20. The media file identifier 20 may identify the media file 12 by the album title, artist name, year the media file 12 was authored, the location where the media file 12 was authored, and the like.

The device further includes a first menu 24 and a second menu 26. The first menu 24 has an identifier list 30, and the identifier list 30 contains each of the plurality of media file identifiers 20. The second menu 26 has a category list 32, and the category list 32 has an arrangement of predefined categories 18. With reference to the method 10 disclosed herein, it is understood that the category list 32 is generated based upon the selection of the media file identifier 20. Thus, if an end-user chooses to browse using the artist name “Dave Mathews Band,” then the category list 32 will contain predefined categories 18 associated with “Dave Mathews Band.”

The device also includes an interface 28 operable to navigate the first and second menu 24, 26. In operation, tie device initially presents the first menu 24 and the interface 28 is operable to choose one of the media file identifiers 20 presented in the identifier list 30 of the first menu 24. Upon choosing a media file identifier 20, the device then presents the second menu 26. The second menu 26 generates a category list 32 so as to present each of the plurality of categories 18 populated with media files 12 tagged with the chosen media file identifier 20, and the interface 28 is operable to selectively play each of the plurality of categories 18 from the category list 32.

The device may further include a port 42 so as to allow media files 12 to be down loaded into the first database 16. The interface 28 is operable to create a plurality of customizable categories 38, and to populate each of the plurality of customizable categories 38 with any of the plurality of media files 12. It is inherent that each of the customizable categories 38 is contained in the first database 16. Thus the category list 32 will further include each of the customizable categories 38, and the second menu 26 is reconfigured so as to present each customizable category 38 and predefined category 18 populated with media files 12 tagged with the chosen media file identifier 20.

In a first preferred embodiment, the device includes a display screen 44 for displaying the first and second menu 24, 26, and the interface 28 is either a touch screen 46 or a function pad 48, also referred to in the art as a key pad, or a D-pad. However, it is understood that the first and second menu 24, 26 may be presented to the user in an audio transmission 50, thus the interface 28 may be operable by voice command.

In operation, the device will present a first menu 24. The end-user may choose from the first menu 24 which of the available media file identifiers 20 with which to browse the first database 16. Upon selection, the second menu 26 appears. The second menu 26 presents a category list 32 generated based upon the media file identifier 20 selected. The category list 32 contains all the categories 18, 38, both predefined and customizable, that have media files 12 tagged with the selected media file identifier 20. The interface 28 is then operable to choose which category 18, 38 to browse. Upon selection, the interface 28 is operable to either play: (1) one of the media files 12 contained therein; (2) all of the media files 12 tagged with the media file 12 indicators contained therein; or (3) all of the media files 12 contained therein regardless of whether the media file 12 is tagged with a media file identifier 20. Thus, with reference to the method 10 described above, in cases where the category is a user created playlist or a compilation, the end-user is able to expand his/her availability of media file selections as the device will present to the user media files 12 that are not directly associated with the initial search criteria.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

What is claimed is:

1. A method for selectively playing media files stored in a media playing device, said method comprising the steps of:
providing a media playing device having a first database populated with a plurality of predefined categories;
loading a plurality of media files into said first database, wherein each of said plurality of media files is tagged with a plurality of media file identifiers;
populating each of said plurality of predefined categories with at least one of said plurality of media files tagged so as to place each of said plurality of media file identifiers in a corresponding predefined category;
providing a search engine for locating each of said plurality of media files based upon said plurality of media file identifiers;
providing a first menu and a second menu,
providing an interface operable to navigate said first and second menu, wherein said first menu presents an identifier list, said identifier list having each of said plurality of media file identifiers, and said interface is operable to choose one of said media file identifiers;
choosing one of said plurality of media file identifiers from said identifier list;
presenting said second menu upon choosing one of said plurality of media file identifiers, wherein said second menu presents a category list, wherein said category list is generated so as to present each of said plurality of predefined categories populated with media files tagged with said chosen media file identifier, and said interface is operable selectively choose one of said plurality of predefined categories, and wherein said interface is operable to selectively play one media file within said selected predefined category, play each media file tagged with said selected media file identifier contained within said selected predefined category, or play all the media files contained within said selected predefined category.

2. A method as set forth in claim 1 including the step of grouping each of said plurality of media file identifiers into a plurality of media file groups.

3. A method as set forth in claim 2 wherein said first menu further includes a media file group list, said media file group list including each of said plurality of media file groups, and wherein said interface operable to selectively choose one of said media file groups from said media file group list, and wherein upon selection of one of said media file groups, said interface further operable to choose one of said media file identifiers from said chosen media file group.

4. A method as set forth in claim 3 wherein said interface is operable to selectively play at least one of said media files tagged with said chosen media file identifiers.

5. A method as set forth in claim 4 further including the step of creating a plurality of customizable categories, wherein said interface is operable to selectively populate each of said plurality of customizable categories with at least one of said plurality of media files, and each of said customizable categories is stored in said first database.

6. A method as set forth in claim 5 wherein said category is generated so as to also include each of said plurality of customizable categories populated with at least one media file tagged with said chosen media file identifier, and said interface if operable to select one of said plurality of customizable categories, and wherein said interface is operable to selectively play one media file within said selected customizable category, play each media file tagged with said selected media file identifier contained within said selected customizable category, or play all the media files contained within said selected customizable category.

7. A method as set forth in claim 6 wherein each of said plurality of predefined categories is selected from the group consisting of album title, artist name, year the media file was authored, playlist, and the location where the media file was authored.

8. A method as set forth in claim 7 wherein said media file identifier is selected from the group consisting of: an artist's name, the year the media file was authored, and the location where the media file was authored.

9. A method as set forth in claim 8 wherein said interface is also operable to selectively play, from said category list, only said media files tagged with said chosen media file identifier.

10. A media playing device for selectively playing a predetermined arrangement of media files comprising:
a housing for containing various electrical components that provide computing operations for said media playing device;
a first database for storing a plurality of predefined categories, each of said plurality of predefined categories containing at least one media file, and each media file is tagged at least one media file identifier;
a first menu and a second menu, said first menu having an identifier list, said identifier list having each of said plurality of media file identifiers, and said second menu having a category list, said category list having each of said plurality of categories and being reconfigurable;
an interface operable to navigate said first and second menu, wherein said device initially provides said first menu and said interface is operable to choose one of said media file identifiers, wherein upon choosing one of said media file identifiers, said device presents said second menu, wherein said second menu presents said category list, and wherein said category list is generated so as to present each of said plurality of predefined categories and each of said plurality of customizable categories populated with media files tagged with said chosen media file identifier, and said interface is operable selectively play each of said plurality of predefined and customizable categories from said category list.

11. A media playing device as set forth in claim 10 further including a port so as to allow media files to be down loaded into said first database.

12. A media playing device as set forth in claim 11 wherein said interface is operable to create a plurality of customizable categories, and said interface is further operable to populate each of said plurality of customizable categories with any of said plurality of media files, and wherein each of said customizable categories is contained in said first database.

13. A media playing device as set forth in claim 12 wherein said category list further includes each of said customizable categories, and said second menu presents said category list, and said category list is generated so as to also present each of said customizable categories populated with media files tagged with said chosen media file identifier.

14. A media playing device as set forth in claim 13 wherein each of said plurality of predefined categories is selected from the group consisting of album title, artist name, year the media file was authored, customizable playlist, and the location where the media file was authored.

15. A media playing device as set forth in claim 14 wherein said media file identifier is selected from the group consisting of album title, artist name, year the media file was authored, and the location where the media file was authored.

16. A media playing device as set forth in claim 10 further including a display screen for displaying said first and second menu.

17. A media playing device as set forth in claim 16 wherein said interface is a touch screen.

18. A media playing device as set forth in claim 16 wherein said interface is a function pad.

19. A media playing device as set forth in claim 10 wherein said first and second menu are presented in an audio transmission.

20. A media playing device as set forth in claim 19 wherein said interface is operable by voice command.
